(19) United States
(12) Patent Application Publication
(10) Pub. No.: US 2026/0147357 A1
(43) Pub. Date: May 28, 2026

(54) COLLABORATIVE ROBOT SYSTEM

(71) Applicant: AISAN KOGYO KABUSHIKI KAISHA, Obu-shi (JP)

(72) Inventors: Taisuke KAGAU, Kariya-shi (JP); Ryosuke MIYACHI, Komaki-shi (JP); Shinji KAWAI, Gifu-shi (JP); Masahi OZEKI, Obu-shi (JP); Yoshihiro SAKUMA, Kariya-shi (JP); Yuma KAKO, Nagoya-shi (JP); Shoichiro SATO, Mizuho-shi (JP)

(21) Appl. No.: 19/396,701

(22) Filed: Nov. 21, 2025

(30) Foreign Application Priority Data
Nov. 25, 2024 (JP) 2024-204891

(51) Int. Cl. G05D 1/644; B25J 19/00

(52) U.S. Cl. CPC G05D 1/644; B25J 19/005

(57) ABSTRACT

A collaborative robot system may include a working robot configured to work with a user at a predetermined location; a battery for supplying power to actuate the working robot; a display unit for displaying a charge level of the battery; a memory unit storing tasks of the working robot; a calculation unit configured to calculate, for each of the tasks of the working robot stored in the memory unit, an expected power amount required for the task of the working robot when it is performed next time based on a power amount consumed for the task of the working robot when it was performed before; and a notification unit configured to notify a timing when the battery is to be charged based on the expected power amount.

### CROSS REFERENCE TO RELATED APPLICATION

This application claims priority to Japanese Patent Application No. 2024-204891 filed on Nov. 25, 2024. The entire content of the priority application is incorporated herein by reference.

### TECHNICAL FIELD

The disclosure herein relates to a collaborative robot system.

### BACKGROUND ART

Japanese Patent Application Publication No. 2009-031992 describes an autonomously movable apparatus configured to autonomously move to a work area and work according to instructions from a user. The autonomously movable apparatus of Japanese Patent Application Publication No. 2009-031992 estimates a power amount required to work according to each instruction from the user, compares the estimated power amount with a remaining power amount, and presents the comparison to the user. In Japanese Patent Application Publication No. 2009-031992, a problem such as incomplete task due to lack of charge is solved by comparing an estimated power amount required to complete work according to the instructions from the user and the remaining power amount.

In the field of robot systems, collaborative robots configured to work with users are known. Tasks and working time of these collaborative robots vary depending on the user. Thus, such a collaborative robot cannot effectively use its battery even if it estimates a required power amount based on the regular tasks and compares it with the remaining power amount, as the autonomously movable apparatus of Japanese Patent Application Publication No. 2009-031992 does. That is, a timing for charging the battery of such a collaborative robot cannot be accurately determined simply by applying the prior art. The disclosure herein aims to provide technology for accurately determining a timing when a collaborative robot is to be charged.

### SUMMARY

According to a first aspect of the technology disclosed herein, a collaborative robot system may comprise a working robot configured to work with a user at a predetermined location; a battery for supplying power to actuate the working robot; a display unit for displaying a charge level of the battery; a memory unit storing tasks of the working robot; a calculation unit configured to calculate, for each of the tasks of the working robot stored in the memory unit, an expected power amount required for the task of the working robot when it is performed next time based on a power amount consumed for the task of the working robot when it was performed before; and a notification unit configured to notify a timing when the battery is to be charged based on the expected power amount.

### BRIEF DESCRIPTION OF DRAWINGS

FIG. 1 illustrates a schematic diagram of a collaborative robot system.

### DETAILED DESCRIPTION

According to a first aspect of the technology disclosed herein, a collaborative robot system may comprise a working robot configured to work with a user at a predetermined location; a battery for supplying power to actuate the working robot; a display unit for displaying a charge level of the battery; a memory unit storing tasks of the working robot; a calculation unit configured to calculate, for each of the tasks of the working robot stored in the memory unit, an expected power amount required for the task of the working robot when it is performed next time based on a power amount consumed for the task of the working robot when it was performed before; and a notification unit configured to notify a timing when the battery is to be charged based on the expected power amount.

According to the first aspect, a power amount required for subsequent tasks can be determined in advance, so that the user can be appropriately informed of the timing for charging the battery. For example, after the completion of morning tasks, a power amount required for tasks to be performed in the afternoon may be compared with the remaining power amount (the charge level of the battery). If the remaining power amount is less than the required power amount, the user can recognize that the battery needs to be charged before the tasks are performed in the afternoon.

In a second aspect of the technology disclosed herein according to the first aspect, the memory unit may store at least one of a workflow for a day on which the collaborative robot system is used and a workflow for the next day.

According to the second aspect, in case the workflow for the day on which the collaborative robot system is used is stored, the remaining power amount (the charge level of the battery) may be compared with a power amount required for the day before the workflow is started. If the remaining power amount is less than the required power amount, the user can charge the battery before starting the workflow for the day. This prevents the workflow from being interrupted to charge the battery. Alternatively, if the remaining power amount is less than the required power amount for the day, the user can choose to use another working robot with a sufficient remaining power amount.

In case the workflow for the next day is stored, the remaining power amount may be compared with a power amount required for the next day at the end of work for the day. If the remaining power amount is less than the required power amount, the user can charge the battery at the end of work. Thus, by the memory unit storing the workflow for the day and/or the workflow for the next day, the working robot can be efficiently charged.

In a third aspect of the technology disclosed herein according to the first or second aspect, the collaborative robot system may further comprise a solar cell, and the solar cell may supply power to the battery.

According to the third aspect, power consumption from the public utility grid can be reduced.

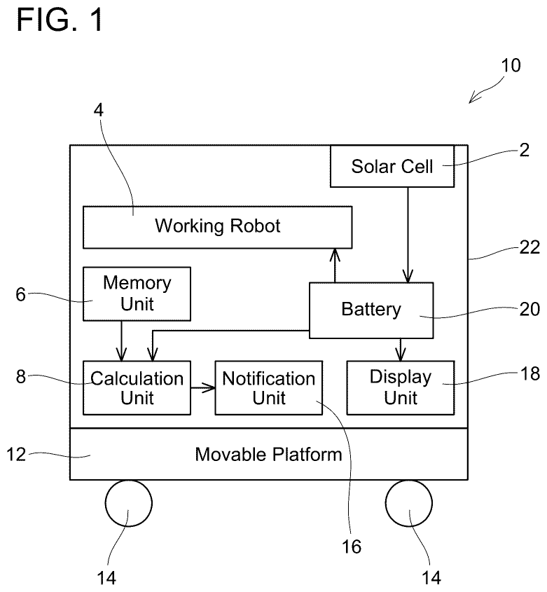

Referring to FIG. 1, a collaborative robot system 10 is described. The collaborative robot system 10 moves with a user to, for example, manufacturing locations (an example of “predetermined location”) within a factory or the like and can be used to move and/or inspect workpieces. The collaborative robot system 10 comprises a movable platform 12 and a collaborative robot 22 mounted on the movable platform 12. The movable platform 12 includes casters 14. Thus, the user can move the collaborative robot 22 from a storage (e.g., a charging area) to the manufacturing locations.

The collaborative robot 22 comprises a battery 20, a working robot 4, a solar cell 2, a display unit 18, a memory unit 6, a calculation unit 8, and a notification unit 16. The battery 20 supplies power to actuate the working robot 4. The battery 20 can be connected to a power supply (not illustrated) to be charged. Alternatively, the battery 20 can be charged with power supplied from the solar cell 2. The display unit 18 can display a remaining battery charge (“charge level”) of the battery 20.

The memory unit 6 stores tasks of the working robot 4. The memory unit 6 also stores a workflow of the day on which the working robot 4 is used and a workflow of the next day. That is, the memory unit 6 stores types of tasks of the working robot 4 and sequences of the tasks on the day and the next day. The workflows are input to the memory unit 6 in advance by the user. The memory unit 6 further stores a consumed power amount for each task, which is a power amount consumed when the task was performed before. For example, the memory unit 6 stores a consumed power amount Q1 for a task W1, a consumed power amount Q2 for a task W2, and a consumed power amount Q3 for a task W3 in association with the tasks W1, W2, and W3, respectively.

The calculation unit 8 calculates, for each of the tasks, an estimated power amount Qp required for the task based on corresponding consumed power amount stored in the memory unit 6. Then, the calculation unit 8 calculates a timing when the battery 20 is to be charged based on the estimated power amounts Qp and the remaining battery charge Qr in the battery 20. The timing calculated by the calculation unit 8 is notified by the notification unit 16. For example, the notification unit 16 may notify a length of time remaining before charging of the battery 20 is to be started. Alternatively, the notification unit 16 may notify a date and time at which charging of the battery 20 is to be started. The timing calculated by the calculation unit 8 is not only notified by the notification unit 16 but may also be displayed on the display unit 18.

As described above, the memory unit 6 stores the workflow for the day on which the working robot 4 is used and the workflow for the next day. For example, in case the workflow for the day indicates that the task W1 is to be performed in the morning and the task W2 is to be performed in the afternoon, the calculation unit 8 calculates estimated power amounts Q12 required to perform the tasks W1 and W2. Then, the calculation unit 8 calculates a timing for charging the battery 20 based on the estimated power amounts Q12 and the remaining battery charge Qr in the battery 20. The timing is notified by the notification unit 16.

The user can check the notification unit 16, and if the timing falls within the working time of the day, charge the battery 20 before the start of work. Alternatively, the user can choose to use another collaborative robot 22 with a sufficient charge level (remaining battery charge Qr) in the battery 20. Alternatively, if the timing falls within the afternoon hours of the day, the user can charge the battery 20 after the morning task W1 has been performed and before the afternoon task W2 is started. This prevents the work of the day from being interrupted due to lack of charge in the battery 20.

For example, if the workflow for the next day indicates that the task W2 is to be performed in the morning and the task W3 is to be performed in the afternoon, the calculation unit 8 calculates estimated power amounts Q23 required to perform the tasks W2 and W3. Then, the calculation unit 8 calculates a charging timing of the battery 20 based on the estimated power amounts Q23 and the remaining battery charge Qr in the battery 20. The charging timing is notified by the notification unit 16. The user can check the notification unit 16, and if the timing falls within the working time of the next day, charge the battery 20 after the work of the day has finished. This prevents the work of the next day from being interrupted due to lack of charge in the battery 20.

After the working robot 4 has performed the tasks W1 and W2 on the day, the memory unit 6 deletes the consumed power amounts consumed when the tasks W1 and W2 were performed before, which are stored in the memory unit 6, and newly stores the consumed power amounts consumed when the tasks W1 and W2 were performed on the day.

The collaborative robot system 10 has advantages described hereinafter. In the collaborative robot system 10, the working robot 4 operates using the charge in the battery 20. Thus, the collaborative robot system 10 does not require a power cable and the like to actuate the working robot 4. This allows the collaborative robot 22 to be used anywhere without limiting the operational area of the collaborative robot 22. Further, the collaborative robot system 10 can notify a charging timing based on the estimated power amounts Qp which will be consumed and the remaining battery charge Qr in the battery 20. This allows the battery 20 to be charged at an appropriate timing and prevents the work from being interrupted due to lack of charge in the battery 20. Moreover, charging the battery 20 at an appropriate timing prevents erroneous charging of the battery 20 and suppresses a reduction in the lifespan of the battery 20.

### Other Embodiments

In the above embodiment, the collaborative robot system comprises a solar cell, however, a solar cell is not a necessary component of the collaborative robot system. Further, the memory unit may store only the workflow for the day or only the workflow for the next day. Alternatively, the memory unit may not store any workflows such as the workflow for the day and the workflow for the next day. What is important for the technology disclosed herein is that the memory unit stores a task performed in the past and a power amount consumed when the task was performed. As long as the consumed power amount for the task performed before is stored, the calculation unit can calculate the estimated power amount required for the task.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is

1. A collaborative robot system comprising:
a working robot configured to work with a user at a predetermined location;
a battery for supplying power to actuate the working robot;
a display unit for displaying a charge level of the battery;
a memory unit storing tasks of the working robot;
a calculation unit configured to calculate, for each of the tasks of the working robot stored in the memory unit, an expected power amount required for the task of the working robot when it is to be performed next time based on a power amount consumed for the task of the working robot when it was performed before; and
a notification unit configured to notify a timing when the battery is to be charged based on the expected power amount.

2. The collaborative robot system according to claim 1,
wherein the memory unit stores at least one of a workflow for a day on which the collaborative robot system is used and a workflow for the next day.

3. The collaborative robot system according to claim 1, further comprising a solar cell,
wherein the solar cell supplies power to the battery.
